(19) United States
(12) Patent Application Publication
(10) Pub. No.: US 2022/0251329 A1
(43) Pub. Date: Aug. 11, 2022

(54) POLYOLEFIN COMPOSITION FOR ENHANCED LASER PRINTING

(71) Applicant: BOREALIS AG, Vienna (AT)

(72) Inventors: Bhawna Kulshreshtha, Linz (AT); Denis Yalalov, Stenungsund (SE); Francis Costa, Linz (AT); Fredrik Bergfors, Goteborg (SE)

(21) Appl. No.: 16/751,592

(22) PCT Filed: Oct. 4, 2018
(86) PCT No.: PCT/EP2018/077018

§ 371 Date: Jan. 24, 2020

(51) Int. Cl. C08K 3/04; C08K 5/3492; C08K 5/00; C08K 5/09; B41M 5/26; H01B 3/44

(52) U.S. Cl. CPC C08K 3/04; C08K 5/3492; H01B 3/441; C08K 5/09; B41M 5/267; C08K 5/0075

(57) ABSTRACT

A polyolefin composition for use as an outer layer of a cable is described, wherein the polyolefin composition comprises a multimodal olefin copolymer and carbon black and UV agent; wherein the multimodal olefin copolymer has density of 0.915-0.960 g/cm3, MFR2 of 0.1-10 g/10 min, wherein carbon black in the polyolefin composition is present in an amount of 0.25-1 wt %, and wherein the polyolefin composition has shrinkage of 1% or lower.

### CROSS-REFERENCE TO RELATED APPLICATIONS

This application is a 371 of PCT Patent Application No. PCT/EP2018/077018, filed on Oct. 4, 2018, which claims the benefit of European Patent Application No. 17194849.0, filed on Oct. 4, 2017, the subject matter of each of which is hereby incorporated herein by reference in its entirety.

### TECHNICAL FIELD

The present invention relates to a polyolefin composition, wherein said polyolefin composition comprises a polyolefin, carbon black and UV agent. Further, the present invention relates use of the polyolefin composition as an outer layer of a cable, and to a method of inducing print on an outer layer of a cable.

### BACKGROUND OF THE INVENTION

In the area of communication cables, marking is necessary in order to provide information to the installer, such that the installation is done correctly and efficiently. For fiber optic micro cables (FOC cables), conventional printing techniques like ink jet, embossing etc. are not suitable, since the outer surface of micro cables is not sufficient for providing a print using the conventional techniques. Therefore, use of laser printing techniques is gaining more importance. The increased need for micro cables have also driven customers towards laser printing. One of the advantages of laser printing is that such printing can be performed at higher line speed compared to the alternatives, thus increasing cost-efficiency. Another advantage is that a laser-induced print cannot be erased by rubbing or friction as opposed to ink-jet print. However, with the laser printing technology, there is a challenge of making a good contrast between dark carbon black filled cable jacketing and light marking. Hence, use of laser printing additives (LPA) is required.

EP 0 947 352 discloses a method for printing by means of a laser beam a character on an inside of a mono-component recipient closure, said closure being made of a plastic material comprising between 0,10% by weight and 1,5% by weight of a laser beam absorbent additive.

For cable manufacturers, the in-line mixing of LPA involves an additional step. Therefore, there is a need for a polyolefin composition, which provides better contrast of laser prints and which do not require any additional manufacturing steps.

U.S. Pat. No. 6,207,344 discloses a resin composition having laser marking properties comprising a polycarbonate resin, an effective amount of a copper chromite having a spinel structure and up to 0.05% by weight of the total composition of carbon black, wherein said polycarbonate resin foams in laser struck areas to form light colored markings in the laser struck areas on a dark background.

EP 0 924 095 discloses a method for marking a polyolefin resin is disclosed which comprises irradiating with a YAG laser a polyolefin resin composition containing 0.1 to 1.0 part by weight of carbon black per 100 parts by weight of the polyolefin resin composition, wherein the carbon black has an average secondary particle size of not smaller than 150 nm.

Using polyolefin compositions as the outer layer of a cable implies high demands on the physical properties of the composition, such as high flexibility, low shrinkage and high Environmental Stress Crack Resistance (ESCR).

Thus, there is still a need for a polyolefin composition suitable for jacketing applications, wherein the required physical properties are combined with excellent printability by laser irradiation.

### SUMMARY OF THE INVENTION

The present invention relates to a polyolefin composition, wherein the polyolefin composition comprises a multimodal olefin copolymer, carbon black and UV agent; wherein the multimodal olefin copolymer has density of 0.915-0.960 g/cm3, MFR2 of 0.1-10 g/10 min, wherein carbon black in the polyolefin composition is present in an amount of 0.25-1 wt %, and wherein the polyolefin composition has shrinkage of 1% or lower. This polyolefin composition has demonstrated to result in a print having a good contrast during laser marking at high speed, and also have excellent shrinkage properties as well as UV ageing properties. The polyolefin composition of the present invention may be used as an outer layer of a cable.

Multimodal Olefin Copolymer

A suitable polyolefin according to the present invention is the polyolefin having properties required in the technical area of jacketing, i.e. a polyolefin providing low shrinkage of 1% or lower, high Environmental Stress Crack Resistance (ESCR) and low Flexural Modulus. Thus, the polyolefin of the present invention preferably has the following ESCR properties:F10>1500 h, more preferably >8000 h; F1>700 h, more preferably >3000 h.

By the “modality” of a polymer is meant the structure of the molecular-weight distribution of the polymer, i.e. the appearance of the curve indicating the number of molecules as a function of the molecular weight. If the curve exhibits one maximum, the polymer is referred to as unimodal, whereas if the curve exhibits a very broad maximum or two or more maxima and the polymer consists of two or more fractions, the polymer is referred to as bimodal, “multimodal” etc. In the following, all polymers whose molecular-weight-distribution curve is very broad or has more than one maximum are jointly referred to as “multimodal”.

The “melt flow rate” (MFR) of a polymer is determined in accordance with ISO 1133, condition 4. The melt flow rate, which is indicated in g/10 min, is an indication of the flowability, and hence the processability, of the polymer. The higher the melt flow rate, the lower the viscosity of the polymer.

By “polyethylene” or “ethylene (co)polymer” is meant an ethylene homopolymer or copolymer. Similarly, by “polypropylene” or “propylene (co)polymer” is meant a propylene homopolymer or copolymer.

By “polyolefin” is meant an olefin homopolymer or copolymer. The olefin monomer is preferably selected from ethylene or propylene. The comonomer is preferably selected from α-olefins having 3-12 carbon atoms, more preferably 1-butene, 1-hexene, 4-methyl-1-pentene, and 1-octene, when the olefin monomer is ethylene. When the olefin monomer is propylene the comonomer is preferably selected from ethylene and α-olefins having 4-12 carbon atoms, more preferably ethylene, 1-butene, 1-hexene, 4-methyl-1-pentene, and 1-octene. The polyolefin may be unimodal or multimodal. Preferably, the polyolefin of the present invention is bimodal.

It is previously known to produce multimodal, in particular bimodal, olefin polymers, preferably multimodal ethylene plastics, in two or more reactors connected in series. As instances of this prior art, mention may be made of EP 040 992, EP 041 796, EP 022 376 and WO 92/12182, which are hereby incorporated by way of reference as regards the production of multimodal polymers. According to these references, each and every one of the polymerisation stages can be carried out in liquid phase, slurry or gas phase.

According to the present invention, the main polymerisation stages are preferably carried out as a combination of slurry polymerisation/gas-phase polymerisation or gas-phase polymerisation/gas-phase polymerisation. The slurry polymerisation is preferably performed in a loop reactor. The use of slurry polymerisation in a stirred-tank reactor is not preferred in the present invention, since such a method is not sufficiently flexible for the production of the inventive composition and involves solubility problems. In order to produce the inventive composition of improved properties, a flexible method is required. For this reason, it is preferred that the composition is produced in two main polymerisation stages in a combination of loop reactor/gas-phase reactor or gas-phase reactor/gas-phase reactor. It is especially preferred that the composition is produced in two main polymerisation stages, in which case the first stage is performed as slurry polymerisation in a loop reactor and the second stage is performed as gas-phase polymerisation in a gas-phase reactor. Optionally, the main polymerisation stages may be preceded by a prepolymerisation, in which case up to 20% by weight, preferably 1-10% by weight, of the total amount of polymers is produced.

Generally, this technique results in a multimodal polymer mixture through polymerisation with the aid of a chromium, metallocene or Ziegler-Natta catalyst in several successive polymerisation reactors. In the production of, say, a bimodal ethylene plastic, which according to the invention is the preferred polymer, a first ethylene polymer is produced in a first reactor under certain conditions with respect to monomer composition, hydrogen-gas pressure, temperature, pressure, and so forth. After the polymerisation in the first reactor, the reaction mixture including the polymer produced is fed to a second reactor, where further polymerisation takes place under other conditions. Usually, a first polymer of high melt flow rate (low molecular weight) and with a moderate or small addition of comonomer, or no such addition at all, is produced in the first reactor, whereas a second polymer of low melt flow rate (high molecular weight) and with a greater addition of comonomer is produced in the second reactor. As comonomer, use is commonly made of other olefines having up to 12 carbon atoms, such as α-olefins having 3-12 carbon atoms, e.g. propene, butene, 4-methyl 1-pentene, hexene, octene, decene, etc., in the copolymerisation of ethylene. The resulting end product consists of an intimate mixture of the polymers from the two reactors, the different molecular-weight-distribution curves of these polymers together forming a molecular weight-distribution curve having a broad maximum or two maxima, i.e. the end product is a bimodal polymer mixture. Since multimodal, and especially bimodal, polymers, preferably ethylene polymers, and the production thereof belong to the prior art, no detailed description is called for here, but reference is had to the above specifications.

It should here be pointed out that, in the production of two or more polymer components in a corresponding number of reactors connected in series, it is only in the case of the component produced in the first reactor stage and in the case of the end product that the melt flow rate, the density and the other properties can be measured directly on the material removed. The corresponding properties of the polymer components produced in reactor stages following the first stage can only be indirectly determined on the basis of the corresponding values of the materials introduced into and discharged from the respective reactor stages.

As hinted at above, it is preferred that the multimodal olefin polymer mixture in the cable-sheathing composition according to the invention is a bimodal polymer mixture. It is also preferred that this bimodal polymer mixture has been produced by polymerisation as above under different polymerisation conditions in two or more polymerisation reactors connected in series. Owing to the flexibility with respect to reaction conditions thus obtained, it is most preferred that the polymerization is carried out in a loop reactor/a gas-phase reactor, a gasphase reactor/a gas-phase reactor or a loop reactor/a loop reactor as the polymerisation of one, two or more olefin monomers, the different polymerisation stages having varying comonomer contents. Preferably, the polymerisation conditions in the preferred two-stage method are so chosen that a comparatively low-molecular polymer having a moderate, low or, which is preferred, no content of comonomer is produced in one stage, preferably the first stage, owing to a high content of chain-transfer agent (hydrogen gas), whereas a high-molecular polymer having a higher content of comonomer is produced in another stage, preferably the second stage. The order of these stages may, however, be reversed.

The multimodal olefin polymer mixture in accordance with the invention may be a mixture of propylene plastics or, which is most preferred, ethylene plastics. The comonomer or comonomers in the present invention are chosen from the group consisting of α-olefins having up to 12 carbon atoms, which in the case of ethylene plastic means that the comonomer or comonomers are chosen from α-olefins having 3-12 carbon atoms. Especially preferred comonomers are butene, 4-methyl-1-pentene, 1-hexene and 1-octene.

In view of the above, a preferred ethylene-plastic mixture according to the invention consists of a low molecular ethylene homopolymer mixed with a high-molecular copolymer of ethylene and butene, 4-methyl-1-pentene, 1-hexene or 1-octene.

The properties of the individual polymers in the olefin polymer mixture according to the invention should be so chosen that the final olefin polymer mixture has a density of about 0.915-0.960 g/cm3, preferably about 0.920-0.950 g/cm3, and a melt flow rate of about 0.1-10 g/10 min, preferably about 0.2-2.0 g/10 min.

According to the invention, the multimodal olefin the olefin polymer mixture comprising a first olefin polymer having a density of about 0.930-0.975 g/cm3, preferably about 0.955-0.975 g/cm3, and a melt flow rate of about 50-2000 g/10 min, preferably about 100-1000 g/10 min, and most preferred about 200-600 g/10 min, and at least a second olefin polymer having such a density and such a melt flow rate that the olefin polymer mixture obtains the density and the melt flow rate indicated above.

If the multimodal olefin polymer mixture is bimodal, i.e. is a mixture of two olefin polymers (a first olefin polymer and a second olefin polymer), the first olefin polymer being produced in the first reactor and having the density and the melt flow rate indicated above, the density and the melt flow rate of the second olefin polymer, which is produced in the second reactor stage, may, as indicated in the foregoing, be indirectly determined on the basis of the values of the materials supplied to and discharged from the second reactor stage.

In the event that the olefin polymer mixture and the first olefin polymer have the above values of density and melt flow rate, a calculation indicates that the second olefin polymer produced in the second stage should have a density in the order of about 0.88-0.93 g/cm3, preferably 0.91-0.93 g/cm3, and a melt flow rate in the order of about 0.01-0.8 g/10 min, preferably about 0.05-0.3 g/10 min.

As indicated in the foregoing, the order of the stages may be reversed, which would mean that, if the final olefin polymer mixture has a density of about 0.915-0.955 g/cm3, preferably about 0.920-0.950 g/cm3, and a melt flow rate of about 0.1-3.0 g/10 min, preferably about 0.2-2.0 g/10 min, and the first olefin polymer produced in the first stage has a density of about 0.88-0.93 g/cm3, preferably about 0.91-0.93 g/cm3, and a melt flow rate of 0.01-0.8 g/10 min, preferably about 0.05-0.3 g/10 min, then the second olefin polymer produced in the second stage of a two-stage method should, according to calculations as above, have a density in the order of about 0.93-0.975 g/cm3, preferably about 0.955-0.975 g/cm3, and a melt flow rate of 50-2000 g/10 min, preferably about 100-1000 g/10 min, and most preferred about 200-600 g/10 min. This order of the stages in the production of the olefin polymer mixture according to the invention is, however, less preferred.

In order to optimise the properties of the polyolefin composition according to the invention, the individual polymers in the olefin polymer mixture should be present in such a weight ratio that the aimed-at properties contributed by the individual polymers are also achieved in the final olefin polymer mixture. As a result, the individual polymers should not be present in such small amounts, such as about 10% by weight or below, that they do not affect the properties of the olefin polymer mixture. To be more specific, it is preferred that the amount of olefin polymer having a high melt flow rate (low-molecular weight) makes up at least 25% by weight but no more than 75% by weight of the total polymer, preferably 35-55% by weight of the total polymer, thereby to optimise the properties of the end product.

The inventive, multimodal olefin polymer mixture described above can be produced in other ways than by polymerisation in two or more polymerisation reactors connected in series, even though this is especially preferred in accordance with the invention. In one alternative aspect of the invention, the multimodal olefin polymer mixture is produced by blending in a melted state of the individual polymers to form part of the olefin polymer mixture. Such melt blending is preferably brought about by coextrusion of the individual polymers, thereby resulting in a mechanical mixture. Since it is difficult, in such melt blending, to achieve satisfactory homogeneity with the final olefin polymer mixture, this way of producing the multimodal olefin polymer mixture is less preferred than the above, preferred method involving polymerisation in polymerisation reactors connected in series.

According to the present invention, multimodal polyethylene may consist of a low-molecular ethylene homopolymer mixed with a high-molecular copolymer of ethylene and butene, 4-methyl-1-pentene, 1-hexene or 1-octene.

Another example of a polyolefin suitable in the present invention is the multimodal olefin copolymer, wherein the copolymer has density of 0.935-0.960 g/cm3 and MFR2 of 2.2-10.0 g/10 min, and the composition has ESCR of at least 2000 hours and cable shrinkage of 0.70% or lower.

The multimodal olefin copolymer in the composition may be a bimodal polymer mixture of a low molecular weight ethylene homo- or copolymer and a high molecular weight copolymer of ethylene and a comonomer selected from the list consisting of 1-butene, 4-methyl-1-pentene, 1-hexene and 1-octene. More conveniently, the multimodal olefin copolymer mixture is a bimodal polymer mixture of a low molecular weight ethylene homopolymer and a high molecular weight copolymer of ethylene and 1-butene.

The multimodal olefin copolymer suitable in the present invention may be produced by a process comprising two main polymerization stages in the presence of a MgCl2 supported catalyst prepared according to a method comprising the steps of: a) providing solid carrier particles of MgCl2*mROH adduct; b) pre-treating the solid carrier particles of step a) with a compound of Group 13 metal; c) treating the pre-treated solid carried particles of step b) with a transition metal compound of Group 4 to 6; d) recovering the solid catalyst component; wherein the solid carrier particles are contacted with an internal organic compound of formula (I) or isomers or mixtures therefrom before treating the solid carrier particles in step c)

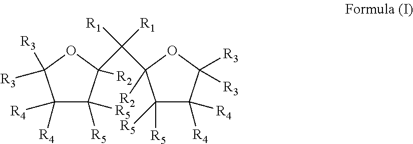

and wherein in the formula (I), R1 to R5 are the same or different and can be hydrogen, a linear or branched C1 to C8-alkyl group, or a C3-C8-alkylene group, or two or more of R1 to R5 can form a ring, the two oxygen-containing rings are individually saturated or partially unsaturated or unsaturated, and R in the adduct MgCl2*mROH is a linear or branched alkyl group with 1 to 12 C atoms, and m is 0 to 6.

Preferably, the two main polymerization stages are a combination of loop reactor/gas phase reactor or gas phase reactor/gas phase reactor. The process may further include a pre-polymerization stage.

The invention is also directed to the use of the MgCl2 supported catalyst prepared according to the method described above (also described in WO2016097193), in the preparation of the cable jacket composition as described in the above variants.

The multimodal olefin copolymer may have an MFR2 of 2.5-8.0 g/10 min. The density is preferably of 0.935-0.950 g/cm3.

Further, the multimodal olefin copolymer of the invention may have MFR5 of higher than 8.0 g/10 min, preferably 9.0 g/10 min, usually between 25.0 g/10 min.

Still further, the multimodal olefin copolymer preferably has Mw of 55000-95000, or even more preferably of 65000-91000. Preferably, the multimodal olefin copolymer has Mn of 6500-11000 or advantageously of 7000-10500. Further, the multimodal olefin copolymer preferably has MWD of 7-12.

Preferably, the multimodal olefin copolymer of the invention has MFR5 of 8.0-25.0 g/10 min, Mw of 55000-95000, Mn of 6500-11000 and MWD of 7-12.

Even more preferably, the multimodal olefin copolymer of the invention has MFR5 of 9.0-25.0 g/10 min, Mw of 65000-91000, Mn of 7000-10500 and MWD of 7-12.

The multimodal olefin copolymer in the composition of the invention may be a bimodal polymer mixture of a low molecular weight homo—or copolymer, preferably a homopolymer, and a high molecular weight copolymer; wherein the low molecular weight ethylene homopolymer has lower molecular weight than the high molecular weight copolymer.

Preferably the low molecular weight homo- or copolymer is an ethylene homo- or copolymer, preferably an ethylene homopolymer and the high molecular weight copolymer is a copolymer of ethylene and a comonomer.

Commonly used comonomers are olefins having up to 12 carbon atoms, such as α-olefins having 3-12 carbon atoms, e.g. propene, butene, 4-methyl 1-pentene, hexene, octene, decene, etc. According to the present invention, the comonomer is selected from the list consisting of 1-butene, 4-methyl-1-pentene, 1-hexene and 1-octene.

More conveniently, the multimodal olefin copolymer of the invention is a bimodal polymer mixture of a low molecular weight ethylene homopolymer and a high molecular weight copolymer of ethylene and 1-butene.

If a polymer consists of only one kind of monomers then it is called a homo-polymer, while a polymer which consists of more than one kind of monomers is called a copolymer. However, according to the invention, the term homopolymer encompasses polymers that mainly consist of one kind of monomer but may further contain comonomers in amounts of 0.09 mol % or lower.

Preferably, the low molecular weight homo- or copolymer has a MFR2 of 25.0-200.0, preferably of 40.0-100.0 g/10 min.

The density of the low molecular weight homo- or copolymer is conveniently of 0.930-0.975 g/cm3.

The high molecular weight copolymer preferably has a density from 0.880-0.930 g/cm3 and a MFR2 from 0.001-1.0 g/10 min, preferably between 0.003 and 0.8 g/10 min.

Preferably, the multimodal olefin copolymer of the invention has MFR5 of 8.0-25.0 g/10 min; and the olefin copolymer is a bimodal polymer mixture of a low molecular weight homo- or copolymer, preferably a homopolymer, and a high molecular weight copolymer, wherein the low molecular weight homo- or copolymer has a density from 0.930-0.975 g/cm3 and a MFR2 of 25.0-200.0 g/10 min, preferably of 40.0-100.0 g/10 min.

It is well known to a person skilled in the art how to produce multimodal, in particular bimodal olefin polymers, or multimodal ethylene polymers, in two or more reactors, preferably connected in series. Each and every one of the polymerization stages can be carried out in liquid phase, slurry or gas phase.

In the production of, say, a bimodal homo- or copolymer, usually a first polymer is produced in a first reactor under certain conditions with respect to monomer composition, hydrogen-gas pressure, temperature, pressure, and so forth. After the polymerization in the first reactor, the reaction mixture including the polymer produced is fed to a second reactor, where further polymerization takes place under other conditions.

Usually, a first polymer of high melt flow rate (low molecular weight) and with a moderate or small addition of comonomer, or no such addition at all, is produced in the first reactor, whereas a second polymer of low melt flow rate (high molecular weight) and with a greater addition of comonomer is produced in the second reactor. The order of these stages may, however, be reversed. Further, an additional reactor may be used to produce either the low molecular weight or the high molecular weight polymer or both.

According to the present invention, the main polymerization stages are preferably carried out as a combination of slurry polymerization/gas-phase polymerization or gas-phase polymerization/gas-phase polymerization. The slurry polymerization is preferably performed in a so called loop reactor.

The composition is preferably produced in two or three main polymerization stages in a combination of loop and gas-phase reactors. It is especially preferred that the composition is produced in three main polymerization stages, in which case the first two stages are performed as slurry polymerization in loop reactors wherein a homopolymer is produced and the third stage is performed as gas-phase polymerization in a gas-phase reactor wherein a copolymer is produced.

The main polymerization stages may be preceded by a pre-polymerization, which may serve to polymerize a small amount of polymer onto the catalyst at a low temperature and/or a low monomer concentration. By prepolymerisation it is possible to improve the performance of the catalyst in slurry and/or modify the properties of the final polymer.

The polymerization in several successive polymerization reactors is preferably done with the aid of a catalyst as described in WO2016/097193.

The catalyst is a MgCl2 supported catalyst prepared according to a method comprising the steps of a) providing solid carrier particles of MgCl2*mROH adduct; b) pre-treating the solid carrier particles of step a) with a compound of Group 13 metal; c) treating the pre-treated solid carried particles of step b) with a transition metal compound of Group 4 to 6; d) recovering the solid catalyst component; wherein the solid carrier particles are contacted with an internal organic compound of formula (I) or isomers or mixtures therefrom before treating the solid carrier particles in step c) and wherein in the formula (I), R1 to R5 are the same or different and can be hydrogen, a linear or branched C1 to C8-alkyl group, or a C3-C8-alkylene group, or two or more of R1 to R5 can form a ring, the two oxygen-containing rings are individually saturated or partially unsaturated or unsaturated, and R in the adduct MgCl2*mROH is a linear or branched alkyl group with 1 to 12 C atoms, and m is 0 to 6.

Magnesium dihalide is normally used as a starting material for producing a carrier. The solid carrier used in this invention is a carrier where alcohol is coordinated with Mg dihalide, preferably MgCl2. The MgCl2 is mixed with an alcohol (ROH) and the solid carrier MgCl2*mROH is formed according to the well know methods. Spherical and granular MgCl2*mROH carrier materials are suitable to be used in the present invention. The alcohol is preferably ethanol. In MgCl2*mROH, m is 0 to 6, more preferably 1 to 4, especially 2.7 to 3.3.

MgCl2*mROH is available from commercial sources or can be prepared by methods described in the art. The solid carrier particles of the invention may consist of MgCl2*mROH.

Group 13 metal compound, used in step b) is preferably an aluminum compound. Preferred aluminum compounds are dialkyl aluminum chlorides or trialkyl aluminum compounds, for example dimethyl aluminum chloride, diethyl aluminum chloride, di-isobutyl aluminum chloride, and triethylaluminum or mixtures there from. Most preferably the aluminum compound is a trialkyl aluminium compound, especially triethylaluminum compound.

The transition metal compound of Group 4 to 6 is preferably a Group 4 transition metal compound or a vanadium compound and is more preferably a titanium compound. Particularly preferably the titanium compound is a halogen-containing titanium compound. Suitable titanium compounds include trialkoxy titanium monochlorides, dialkoxy titanium dichloride, alkoxy titanium trichloride and titanium tetrachloride. Preferably, titanium tetrachloride is used.

In formula (I), examples of preferred linear or branched C1 to C8-alkyl groups are methyl, ethyl, n-propyl, i-propyl, n-butyl, sec-butyl, tert-butyl, pentyl and hexyl groups. Examples for preferred C3-C8-alkylene groups are pentylene and butylene groups. The two R1 are preferably the same and are a linear C1 to C4-alkyl groups, more preferably methyl or ethyl. R2 to R5 are the same or different and are preferably H or a C1 to C2-alkyl groups, or two or more of R2 to R5 residues can form a ring. Most preferably R2 to R5 are all H.

Furthermore, both oxygen-containing rings are preferably saturated or partially unsaturated or unsaturated. More preferably both oxygen-containing rings are saturated. Examples of preferred internal organic compounds are 2,2-di(2-tetrahydrofuryl)propane, 2,2-di(2-furan)propane, and isomers or mixtures thereof. Most preferably, 2,2-di(2-tetrahydrofuryl)propane (DTHFP) is used with the isomers thereof. DTHFP is typically a 1:1 mol/mol diastereomeric mixture of D,L-(rac)-DTHFP and meso-DTHFP.

The molar ratio of the internal organic compound of formula (I)/the adduct MgCl2*mROH added to the catalyst mixture is in the range of 0.02 to 0.20 mol/mol, preferably 0.05 to 0.15 mol/mol.

The Al compound can be added to the solid carrier before or after adding the internal organic compound or simultaneously with the internal organic compound to the carrier. Most preferably in any case, m is 2.7 to 3.3, ROH is ethanol, aluminum compound is an aluminum trialkyl compound, such as triethylaluminum, and as internal donor is used 2,2-di(2-tetrahydrofuryl)propane, or 2,2-di-(2-furan)propane, especially 2,2-di(2-tetrahydrofuryl)propane or isomers or mixtures thereof.

The final solid catalyst component shall have Mg/Ti mol/mol ratio of 1 to 10, preferably 2 to 8, especially 3 to 7, Al/Ti mol/mol ratio 0.01 to 1, preferably 0.1 to 0.5 and Cl/Ti mol/mol ratio of 5 to 20, preferably 10 to 17.

The resulting end product consists of an intimate mixture of the polymers from the reactors, the different molecular weight distribution curves of these polymers together forming a molecular weight distribution curve having a broad maximum or two maxima, i.e. the end product is a bimodal polymer mixture.

According to the invention, it is preferred that the amount of olefin polymer having a high melt flow rate (low-molecular weight) makes up at least 30% by weight but no more than 65% by weight of the total polymer, preferably 35-62% by weight of the total polymer. Preferably, the amount of olefin polymer having a low melt flow rate (high-molecular weight) makes up at least 35% by weight but no more than 70% by weight of the total polymer, preferably 38-65% by weight of the total polymer.

According to one embodiment, the composition may further comprise conductive filler in an amount up to 5 wt % or up to 3 wt % of the entire composition. The filler is conveniently carbon black. Preferably, the carbon black is added to the composition in a master-batch on a polymer carrier.

Preferably, the polyolefin composition of the invention has cable shrinkage of 0.70% or lower, preferably of 0.60 or lower. The shrinkage is usually of 0.40-0.70% or preferably 0.40-0.60%.

Carbon Black

It should be noted that in jacketing of FOC of prior art, the amount of carbon black is at least 2.5 wt %. This amount of carbon black is necessary in order to provide sufficient UV stability of the jacketing layer.

The base resin comprising 0.25-1 wt % carbon black provides a light-coloured visible marking with good contrast towards dark background of black colour. It is believed that the irradiation from the laser beam decomposes the carbon black into volatile components. These volatile components as well as the absorption of heat from the laser beam foam the surface, which scatters light and leaves a light-colored impression. A polyolefin composition comprising carbon black in the range varying from 0.25 to 1 wt % exhibits a superior performance for laser marking. In the presence of a higher amount of carbon black, laser marking efficiency deteriorates, and when the amount of carbon black is above 1 wt %, poor contrast is achieved.

Preferably, the amount of carbon black in the polyolefin composition is 0.25-0.75 wt %, more preferably 0.25-0.5 wt %.

UV Agent

As mentioned above, it has been noted that at carbon black loadings below 2.5 wt %, degradation of the base resin of the outer layer of FOC caused by UV irradiation may occur. The present invention addresses this problem by providing a polyolefin composition comprising a UV-absorbing agent along with an optimum amount of carbon black. The amount of UV agent may be 0.1-1 wt %, preferably 0.2-0.5 wt % and most preferably 0.2-0.3 wt %. Suitable UV agents are benzoates, triazoles, triazines or hindered amines. Particularly, a mixture of equal amounts of dimethyl succinate polymer with 4-hydroxy-2,2,6,6,-tetramethyl-1-piperidineethanol and Poly[[6-[(1,1,3,3-tetramethylbutyl)amino]-1,3,5-triazine-2,4-diyl](2,2,6,6-tetramethyl-4-piperidinyl)imino]-1,6-hexanediyl[(2,2,6,6-tetramethyl-4-piperidinyl)imino]]) (Tinuvin 783 FDL obtained from BASF) may be used as UV-agent. The UV agent is added in order to compensate the lack of carbon black

Other Additives

Polyolefin composition according to the present invention may further comprise antioxidant, such as sterically hindered phenol, phosphorus-based antioxidant, sulphur-based antioxidant, nitrogen-based antioxidant, or mixtures thereof. In particular, a mixture of equal amounts of pentaerythritol tetrakis(3-(3,5-di-tert-butyl-4-hydroxyphenyl)propionate) and tris(2,4-di-tert-butylphenyl) phosphite (Irganox B225) may be used as antioxidant. The antioxidant may be present in an amount of 0.1-1 wt % based on the total amount of the polyolefin composition.

Polyolefin composition according to the present invention may further comprise antistatic agent, such as calcium stearate, sodium stearate or zinc stearate. The antistatic agent may be present in an amount of 0.1-1 wt % based on the total amount of the polyolefin composition.

According to the present invention, the polyolefin composition may comprise both antioxidant and antistatic agent.

By using the polyolefin composition of the present invention as the outer layer of a cable, in particular a FOC cable, a clear and distinct print is obtained without the need of adding print enhancers, resulting in a superior and cost-efficient production process and eliminating the shortcomings of the prior art.

The present invention further relates to a method of inducing print on an outer layer of a cable, wherein the outer layer comprises a polyolefin composition comprising a polyolefin and carbon black in the amount of 0.25-1 wt %, and wherein the print is induced by laser radiation. The laser used for the present invention is any conventional laser that may be used for inducing print, and that is well known to a person skilled in the art. The frequency of the laser may be 20-100 kHz, and the power may be 2-50 W, preferably 3-20 W, more preferably 4.65-13 W.

The present invention also relates to an outer layer of a cable, comprising a polyolefin composition comprising a polyolefin and carbon black in the amount of 0.25-1 wt %.

### BRIEF DESCRIPTION OF THE DRAWINGS

Embodiments of the invention will now be described by way of examples with reference to the accompanying drawings, of which:

FIGS. 1-4 show printed samples with a combination of carbon black and UV agent. The amount of carbon black is 0.25 wt % in FIG. 1, 0.5 wt % in FIG. 2, 0.75 wt % in FIGS. 3 and 1 wt % in FIG. 4.

### DETAILED DESCRIPTION OF THE INVENTION

1. Materials

PE1 is poly(ethylen-co-(1-butene)) copolymer with 39% of carbon black additive

PE2 is bimodal high density polyethylene. Comparative PE3 is black bimodal high density polyethylene. The properties of PE2 and PE3 are summarized in Table 1.

TABLE 1
Properties of the base resin PE2 in Samples 1-4

| Property | PE2 | PE3 | Analysis method |
|---|---|---|---|
| Density (Compound) | 944 kg/m³ | 954 kg/m³ | ISO 1183 |
| Melt Flow Rate (190° C./2.16 kg) | 1.7 g/10 min | 1.7 g/10 min | ISO 1133 |
| Flexural Modulus | 850 MPa | 900 MPa | ASTM D 790 |
| Tensile Strain at Break (50 mm/min) | 900% | 900% | ISO 527 |
| Tensile Strength (50 mm/min) | 31 MPa | 29 MPa | ISO 527 |
| Brittleness temperature | <−76° C. | <−76° C. | ASTM D 746 |
| Environmental Stress Crack Resistance | >5.000 h | >5.000 h | IEC 60811-406 |
| (50° C., lgepal 10%, F0) | | | |
| Hardness, Shore D (1 s) | 61 | 61 | ISO 868 |
| Pressure Test at High Temperature | <10% | <10 % | IEC 60811-508 |
| (115° C., 6 h) | | | |

The antioxidant is lrganox B225 obtained from BASF.

The antistatic agent is Ceasit SW (calcium stearate) obtained from Baerlocher. The UV agent is Tinuvin 783 FDL obtained from BASF.

2. Methods

Filler Content

The amount of carbon black is measured through combustion of the material in a tube furnace in nitrogen atmosphere. The sample is weighted before and after the combustion. The combustion temperature is 550° C. The result is based on one measurement. The method is according to ASTM D1603.

The amount of CB may also be determined using FT IR spectroscopy as is well known to a person skilled in the art.

Comonomer Content

Quantitative nuclear-magnetic resonance (NMR) spectroscopy is used to quantify the comonomer content of the polymers.

Quantitative 13C{1H} NMR spectra are recorded in the molten-state using a Bruker Advance III 500 NMR spectrometer operating at 500.13 and 125.76 MHz for 1H and 13C respectively. All spectra are recorded using a 13C optimized 7 mm magic-angle spinning (MAS) probe-head at 150° C. using nitrogen gas for all pneumatics. Approximately 200 mg of material is packed into a 7 mm outer diameter zirconia MAS rotor and spun at 4 kHz. This setup is chosen primarily for the high sensitivity needed for rapid identification and accurate quantification (Klimke et al, Macromol. Chem. Phys. 2006; 207:382; Parkinson et al, Macromol. Chem. Phys. 2007; 208:2128; Castignolles et al, M., Polymer 50 (2009) 2373).

Standard single-pulse excitation is employed utilizing the transient NOE at short recycle delays of 3s (Pollard et al, Macromolecules 2004; 37:813; Klimke et al, Macromol. Chem. Phys. 2006; 207:382) and the RS-HEPT decoupling scheme (Filip et al, J. Mag. Resn.

2005, 176, 239; Griffin et al, Mag. Res. in Chem. 2007 45, S1, S198). A total of 1024 (1k) transients are acquired per spectrum. This setup is chosen due its high sensitivity towards low comonomer contents.

Quantitative 13C{1H} NMR spectra are processed, integrated and quantitative properties determined using custom spectral analysis automation programs. All chemical shifts are internally referenced to the bulk methylene signal (δ+) at 30.00 ppm (J. Randall, Macromol. Sci., Rev. Macromol. Chem. Phys. 1989, C29, 201).

Characteristic signals corresponding to the incorporation of 1-butene are observed (J. Randall, Macromol. Sci., Rev. Macromol. Chem. Phys. 1989, C29, 201) and all contents calculated with respect to all other monomers present in the polymer.

Characteristic signals resulting from isolated 1-butene incorporation i.e. EEBEE comonomer sequences, are observed. Isolated 1-butene incorporation is quantified using the integral of the signal at 39.84 ppm assigned to the *B2 sites, accounting for the number of reporting sites per comonomer:

B=I*B2

When characteristic signals resulting from consecutive 1-butene incorporation i.e. EBBE comonomer sequences are observed, such consecutive 1-butene incorporation is quantified using the integral of the signal at 39.4 ppm assigned to the ααB2B2 sites accounting for the number of reporting sites per comonomer:

BB=2*IααB2B2

When characteristic signals resulting from non consecutive 1-butene incorporation i.e. EBEBE comonomer sequences are also observed, such non-consecutive 1-butene incorporation is quantified using the integral of the signal at 24.7 ppm assigned to the ßßB2B2 sites accounting for the number of reporting sites per comonomer:

BEB=2*IßßB2B2

Due to the overlap of the *B2 and *ßB2B2 sites of isolated (EEBEE) and non-consecutively incorporated (EBEBE) 1-butene respectively the total amount of isolated 1-butene incorporation is corrected based on the amount of non-consecutive 1-butene present:

B=I*B2−2*IßßB2B2

With no other signals indicative of other comonomer sequences, i.e. butene chain initiation, observed the total 1-butene comonomer content is calculated based solely on the amount of isolated (EEBEE), consecutive (EBBE) and non-consecutive (EBEBE) 1-butene comonomer sequences:

Btotal=B+BB+BEB

Characteristic signals resulting from saturated end-groups are observed. The content of such saturated end-groups is quantified using the average of the integral of the signals at 22.84 and 32.23 ppm assigned to the 2s and 3s sites respectively:

S=(½)*(I2s+I3s)

The relative content of ethylene is quantified using the integral of the bulk methylene (δ+) signals at 30.00 ppm:

E=(½)*δ+

The total ethylene comonomer content is calculated based the bulk methylene signals and accounting for ethylene units present in other observed comonomer sequences or end-groups:

Etotal=E+( 5/2)*B+( 7/2)*BB+( 9/2)*BEB+( 3/2)*S

The total mole fraction of 1-butene in the polymer is then calculated as: fB=Btotal/(Etotal+Btotal)

The total comonomer incorporation of 1-butene in mole percent is calculated from the mole fraction in the usual manner:

B[mol %]=100*fB

The total comonomer incorporation of 1-butene in weight percent is calculated from the mole fraction in the standard manner:

B[wt %]=100*(fB*56.11)/((fB*56.11)+((1−fB)*28.05))

Mw, Mn

Molecular weight averages (Mw and Mn), Molecular weight distribution (MWD) and its broadness, described by polydispersity index, PDI=Mw/Mn (wherein Mn is the number average molecular weight and Mw is the weight average molecular weight) are determined by Gel Permeation Chromatography (GPC) according to ISO 16014-1:2003, ISO 16014-2:2003, ISO 16014-4:2003 and ASTM D 6474-12 using the following formulas:

For a constant elution volume interval ΔVi, where Ai, and Mi are the chromatographic peak slice area and polyolefin molecular weight (MW), respectively associated with the elution volume, Vi, where N is equal to the number of data points obtained from the chromatogram between the integration limits.

A high temperature GPC instrument, equipped with either infrared (IR) detector (IR4 or IR5 from PolymerChar (Valencia, Spain) or differential refractometer (RI) from Agilent Technologies, equipped with 3×Agilent-Plgel Olexis and 1× Agilent-Plgel Olexis Guard columns is used. As the solvent and mobile phase 1,2,4-trichlorobenzene (TCB) stabilized with 250 mg/L 2,6-Di tert butyl-4-methyl-phenol) is used. The chromatographic system is operated at 160° C. and at a constant flow rate of 1 ml/min. 200 μL of sample solution is injected per analysis. Data collection is performed using either Agilent Cirrus software version 3.3 or PolymerChar GPC-IR control software.

The column set is calibrated using universal calibration (according to ISO 16014-2:2003) with 19 narrow MWD polystyrene (PS) standards in the range of 0.5 kg/mol to 11 500 kg/mol. The PS standards are dissolved at room temperature over several hours. The conversion of the polystyrene peak molecular weight to polyolefin molecular weights is accomplished by using the Mark Houwink equation and the following Mark Houwink constants:

$${K}_{P S} = 19 * 1 {0}^{- 3} \frac{m L}{g} {∝}_{PS} = 0.655 \\ {K}_{P E} = 39 * 1 {0}^{- 3} \frac{m L}{g} {∝}_{PE} = 0.725 \\ {K}_{P P} = 19 * 1 {0}^{- 3} \frac{m L}{g} {∝}_{PP} = 0.725$$

A third order polynomial fit is used to fit the calibration data.

All samples are prepared in the concentration range of 0,5−1 mg/ml and dissolved at 160° C. for 2.5 hours for PP or 3 hours for PE under continuous gentle shaking.

As it is known in the art, the weight average molecular weight of a blend can be calculated if the molecular weights of its components are known according to:

$$M {w}_{b} = {\sum }_{i} {w}_{i} \cdot {Mw}_{i}$$

where Mwb is the weight average molecular weight of the blend, wi is the weight fraction of component “i” in the blend and Mwi is the weight average molecular weight of the component “i”.

The number average molecular weight can be calculated using the mixing rule:

$$\frac{1}{{Mn}_{b}} = {\sum }_{i} \frac{{w}_{i}}{{Mn}_{i}}$$

where Mnb is the number average molecular weight of the blend, wi is the weight fraction of component “i” in the blend and Mni is the number average molecular weight of the component “i”.

Cable Extrusion

The cable extrusion is done on a Nokia-Maillefer cable line. The extruder has five temperature zones with temperatures of 1701175118011901190° C. and the extruder head has three zones with temperatures of 210/210/210° C. The extruder screw is a barrier screw of the design Elise. The die is a semi-tube on type with 5.9 mm diameter and the outer diameter of the cable is 5 mm. The compound is extruded on a 3 mm in diameter, solid aluminum conductor to investigate the extrusion properties. Line speed is 75 m/min.

The pressure at the screen and the current consumption of the extruder is recorded for each material.

Cable Shrinkage

The shrinkage of the composition is determined with the cable samples obtained from the cable extrusion. The cables are conditioned in the constant room at least 24 hours before the cutting of the samples. The conditions in the constant room are 23±2° C. and 50±5% humidity. Samples are cut to 400 mm at least 2 m away from the cable ends. They are further conditioned in the constant room for 24 hours after which they are place in an oven on a talcum bed at 100° C. for 24 hours. After removal of the sample from the oven they are allowed to cool down to room temperature and then measured. The shrinkage is calculated according to formula below:

[(LBefore−LAfter)/LBefore]×100%, whereinL is length.

UV Ageing

UV ageing was performed according to VW PV 3930—Weathering in Moist, Hot Climate” or “Florida test” performed according to DIN EN ISO 4892-02.

Tensile Properties

Specimen was made according to ISO-527-2 5A. Test method of ISO 527-1,-2:2012, method B was used, employing extensometer Zwick MultiXtens, and evaluated according to ISO 527-1, method B.

Nominal tensile strain at break was measured according to ISO 527-1,-2:2012 Method B-Extensometer till Yield+Crosshead till break) 3. Results

Four samples were prepared using the carbon black masterbatch (MB) in PE1 carrier, wherein the carbon black MB was compounded with polymer base resin PE2, in an amount such that the amount of CB in the final composition is 0.25-1 wt % for Sample 1-4 (Table 2). Compounding was implemented on ZSK 18 MEGAlab laboratory twin screw extruder under the following conditions: speed=200 rpm; melt temperature 175-190° C.; pressure 45-50 bar; output 5 kg/h. Plaques of size 150*80*3 mm were produced from the resulting composition using injection moulding on Engel ES 700H/80V/700H/250 3K machine under following conditions: injection speed=11 mm/s; injection time 3.4 sec; switching pressure 66 bar; holding time during backpressure 15 sec; cooling time 20 sec; cycle time 45 sec; melt temperature 150° C.; mould temperature 50° C.

TABLE 2
Compounding of Samples 1-4

| | Comp. | | | | |
|---|---|---|---|---|---|
| Components | Sample | Inv. | Inv. | Inv. | Inv. |
| (wt %) | PE3 | Sample 1 | Sample 2 | Sample 3 | Sample 4 |
| PE2 | | 99.1 | 98.85 | 98.6 | 98.35 |
| Antioxidant | | 0.2 | 0.2 | 0.2 | 0.2 |
| Antistatic agent | | 0.15 | 0.15 | 0.15 | 0.15 |
| UV-agent | | 0.3 | 0.3 | 0.3 | 0.3 |
| Carbon black | 2.6 | 0.25 | 0.5 | 0.75 | 1 |
| Shrinkage (%) | 1.05 | <1 | <1 | — | — |

Laser Marking Behaviour

Laser marking was carried out using Laser machine, SpeedMarker 700, 20W Fiber laser. For marking, a frequency range of 20-100 KHz and power varying between 5-70% of 20W was used. Speed was kept constant at 2000 mm/s.

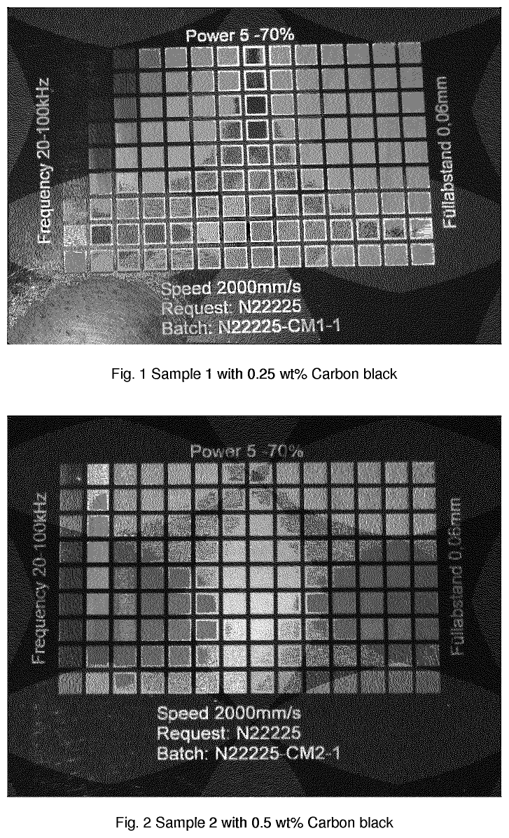

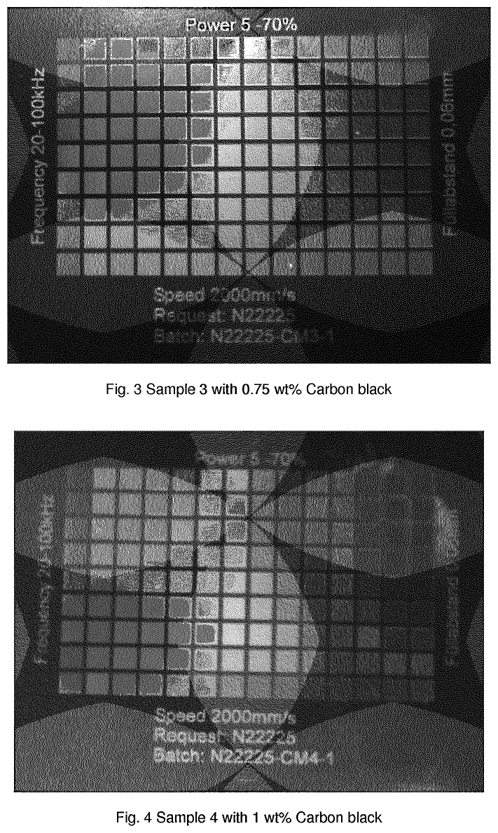

FIGS. 1-4 show laser printed samples with a combination of different amounts of carbon black and UV agent. Each square represents a combination of frequency to power. The samples are assessed visually by a human being. Best contrast quality is achieved using 0.25% of carbon black (FIG. 1). As may be seen, the contrast becomes poor if the amount of carbon black present exceeds 0.5 wt % (FIGS. 3 and 4).

As may be seen in Table 2, the inventive samples showed excellent shrinkage of below 1%.

TABLE 3
UV ageing properties
Ageing

| | | | | |
|---|---|---|---|---|
| 0 | 507 | 1008 | 4000 | 6000 |

Tensile stress at break, MPa

| | | | | | |
|---|---|---|---|---|---|
| Inv. Sample 1 | 24.64 | 21.79 | 24.12 | 26.07 | 26.14 |
| Inv. Sample 2 | 26.46 | 21.74 | 24.54 | 24.01 | 22.19 |
| Comp. Sample | 25.3 | 24.74 | 21.93 | 18.83 | 23.99 |

Nominal tensile strain at break, %

| | | | | | |
|---|---|---|---|---|---|
| Inv. Sample 1 | 547.48 | 453.65 | 507.1 | 561.33 | 561.55 |
| Inv. Sample 2 | 572.33 | 429.65 | 517.66 | 522.21 | 483.12 |
| Comp. Sample | 582.85 | 548.2 | 502.53 | 509.2 | 541.12 |

As may be seen in Table 3, the inventive samples exhibit excellent UV ageing properties.

Although the present invention has been described with reference to various embodiments, those skilled in the art will recognize that changes may be made without departing from the scope of the invention. It is intended that the detailed description be regarded as illustrative, and that the appended claims including all the equivalents are intended to define the scope of the invention.

1. A polyolefin composition, wherein said polyolefin composition comprises a multimodal olefin copolymer and carbon black and UV agent;
wherein said multimodal olefin copolymer has density of 0.915-0.960 g/cm³, MFR2 of 0.1-10 g/10 min,
wherein carbon black in said polyolefin composition is present in an amount of 0.25-1 wt %, and
wherein said polyolefin composition has shrinkage of 1% or lower.

2. The polyolefin composition according to claim 1, wherein said UV agent is present in said polyolefin composition in an amount of 0.1-1 wt %.

3. The polyolefin composition according to claim 1, wherein said UV agent is a mixture of equal amounts of dimethyl succinate polymer with 4-hydroxy-2,2,6,6,-tetramethyl-1-piperidineethanol and poly[[6-[(1,1,3,3-tetramethylbutyl)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]]).

4. The polyolefin composition according to claim 1, wherein said composition further comprises an antioxidant or an antistatic agent, or both.

5. The polyolefin composition according to claim 4, wherein said antistatic agent is stearate.

6. The polyolefin composition according to claim 4, wherein said antioxidant is a mixture of equal amounts of pentaerythritol tetrakis(3-(3,5-di-tert-butyl-4-hydroxyphenyl)propionate) and tris(2,4-di-tert-butylphenyl) phosphite.

7. The polyolefin composition according to claim 1, wherein said multimodal olefin copolymer is an ethylene polymer mixture.

8. The polyolefin composition according to claim 1, wherein said multimodal olefin copolymer is a bimodal polymer mixture of a low molecular weight ethylene homo- or copolymer and a high molecular weight copolymer of ethylene and a comonomer selected from the list consisting of 1-butene, 4-methyl-1-pentene, 1-hexene or 1-octene.

9. The composition according to claim 1, wherein the multimodal olefin copolymer mixture is a bimodal polymer mixture of a low molecular weight ethylene homopolymer and a high molecular weight copolymer of ethylene and 1-butene.

10. The polyolefin composition according to claim 1, wherein the amount of carbon black in said polyolefin composition is 0.25-0.75 wt %, preferably 0.25-0.5 wt %.

11. The polyolefin composition according to claim 1, wherein the shrinkage is 0.70% or lower, preferably of 0.60% or lower.

12. A method of inducing print on an outer layer of a cable, wherein said outer layer comprises a polyolefin composition according to claim 1, and said print is induced by laser radiation.

13. The method according to claim 12, wherein the frequency of said laser is 20-100 kHz.

14. The method according to claim 12, wherein the power of said laser is 2-50W.

15. An outer layer of a cable, comprising a polyolefin composition according to claim 1.
